(19) United States
(12) Patent Application Publication
(10) Pub. No.: US 2010/0008092 A1
(43) Pub. Date: Jan. 14, 2010

(54) SWIVELLING LIGHTING APPLIANCE

(76) Inventors: Giampaolo Targetti, Firenze (IT); Giampiero Gianassi, Firenze (IT)

Correspondence Address: Steinfl & Bruno, 301 N Lake Ave Ste 810, Pasadena, CA, 91101, US

(21) Appl. No.: 12/524,676

(22) PCT Filed: Jan. 31, 2008
(86) PCT No.: PCT/IB08/50341

§ 371 Date: Jul. 27, 2009

(30) Foreign Application Priority Data
Feb. 2, 2007 (IT) FI2007A000023

(51) Int. Cl. F21V 21/30

(52) U.S. Cl. 362/287

(57) ABSTRACT

A lighting appliance of the type designed for enabling the luminous beam produced to be variously oriented, comprising: a) a lamp body (13) with a reflector (20), b) first means (14) for swivelling the lamp body (13) around an first axis (15) pointing substantially towards the area to be illuminated, c) second means (16) for swivelling the lamp body (13) around a second axis (17), lying crosswise to the first axis (15), designed for adjusting the tilting angle of the reflector (20). The first swivelling means (14) consist of a turning pair (22, 23) formed by two component kinematic parts (22, 23). A first part (22) consists of two opposite concave tracks (26a, 26b) with opposite concave sides facing one another and towards said first axis (15). These two tracks (26a, 26b) are elastically deformable and thrusting against the second component part (23) of the turning pair (22-23) so as to generate friction.

### FIELD OF THE INVENTION

The present invention generally relates to the field of lighting appliances. In particular, it concerns a lighting appliance of the type designed to enable the luminous beam produced to be variously oriented.

### STATE OF THE ART

There are known types of lighting appliance generally comprising a lamp body consisting of a circular frame to which a reflector is attached, the latter containing a light source, such as a halogen bulb, to connect to an electric power supply. The frame is attached to a supporting structure, the form of which is dependent on the intended use of the appliance. For instance the supporting structure may be in the form of a chandelier or other lighting appliance for suspending from the ceiling or attaching to a wall. As a further possibility, the supporting structure may be in the form of a panel for attaching to a wall or false ceiling, with a hole for flush mounting the appliance.

In addition to the above-mentioned component parts, the lighting appliances of the above mentioned type also comprise means for swivelling the lamp body around a first axis substantially pointing towards the area to be illuminated, and also around a second axis orthogonal to said first axis. Such means allow to adjust the reflector tilt and its angular position when tilted.

In a typical embodiment, the swivelling means comprise two pins projecting radially from two diametrically opposite positions on the circular frame and engaging slidingly in a anular groove formed in the inner wall of a hole arranged in the body or in the panel defining the supporting structure in which the appliance is inserted.

The frame, and consequently also the reflector integrally attached thereto, can rotate around the pin axis; said rotation allows the reflector tilt adjustment. Moreover, the fact that the pins can slide in the groove defined in the inner wall of the hole enables a further rotation of the lamp body (and consequently of the reflector) around an axis pointing towards the area to be illuminated, thereby enhancing the adjustability of the reflector's orientation.

The above-mentioned pins are housed in corresponding seats and forced to project from their seats due to the thrust of corresponding helical springs arranged between the base of the pins and the bottom of the seats. This ensures the mounting of the appliance to the supporting structure and, at the same time, it achieves the necessary friction between the pins and the groove to enable the lamp body to occupy stable positions along the groove.

Though the structural solution described above is well known and has been appreciated by the market for some time now, it could be improved upon in several ways relating to the fact that the groove on the inner wall of the hole provided in the supporting structure is relatively costly to prepare, and to the fact that it is not easy to ensure that the lamp body maintains a titled position around the axis defined by the pins.

When the supporting structure consists of a panel, moreover, the need to make the groove on the inner wall of the hole prevents the use of panels of small thickness.

Furthermore, a lighting appliance structure such as the one described above is unsuitable for flush mounting on supporting structures with a convex or concave shape, as in the case, for instance, of the panels for flush mounting the appliance following a curved profile. In fact, the groove in such a panel follows the convex or concave profile of the panel, so the trajectory of the pins is not on a plane. Being co-axial, the pins cannot follow the profile with inverted slants that the groove presents in corresponding diametrically opposite portions; this inevitably leads to the pin sticking in the groove, consequently making it impossible to rotate the appliance.

The main aim of the present invention is to overcome the above-identified drawbacks relating to the structure of the above-described lighting appliance.

Within this aim, an important object of the present invention is to provide a lighting appliance of swivelling type, that allows a stable orientation of the luminous beam produced.

Another object of the present invention is to realise such a lighting appliance of swivelling type, that can be attached to supporting structures (e.g. panels) having a concave or convex profile.

It is a further object of the present invention to provide a swivelling lighting appliance that can be attached to thin panels.

Another object of the present invention is to provide a swivelling lighting appliance that allows to avoid expansive manufacturing on the supporting structure with which the appliance is associated.

Another object of the present invention is to provide a swivelling lighting appliance with a simple structure.

### SUMMARY OF THE INVENTION

These objects are achieved by a flush mounted lighting appliance of the type designed for housing in a hole formed in a panel of a wall or of a false ceiling, comprising:
a lamp body comprising a reflector in which a light source can be housed,
first means for swivelling the lamp body around a first axis pointing substantially towards the area to be illuminated,
second means for swivelling the lamp body around a second axis, lying crosswise to the first axis, to adjust the tilting angle of the reflector,
   characterised in that the first swivelling means comprise a turning pair with an axis of rotation coinciding with the first axis, the two kinematic component parts of the turning pair are respectively associated with means for attaching the turning pair to the panel in which the appliance is flush mounted and with means for restraining the turning pair to the lamp body. Of the two kinematic component parts, a first part comprises at least two opposite concave tracks with concave sides facing one another and towards the first axis, at least one of these two tracks being elastically deformable and thrusting against the second component part of the turning pair so as to generate friction.

### BRIEF DESCRIPTION OF THE DRAWINGS

The characteristics and advantages of the lighting appliance according to the present invention will be made apparent from the following description of an embodiment thereof made as a non-limiting example with reference to the appended drawings, wherein:

FIG. 1 is a perspective view of a lighting appliance according to the invention attached to a convex panel, shown on the side not exposed to view;

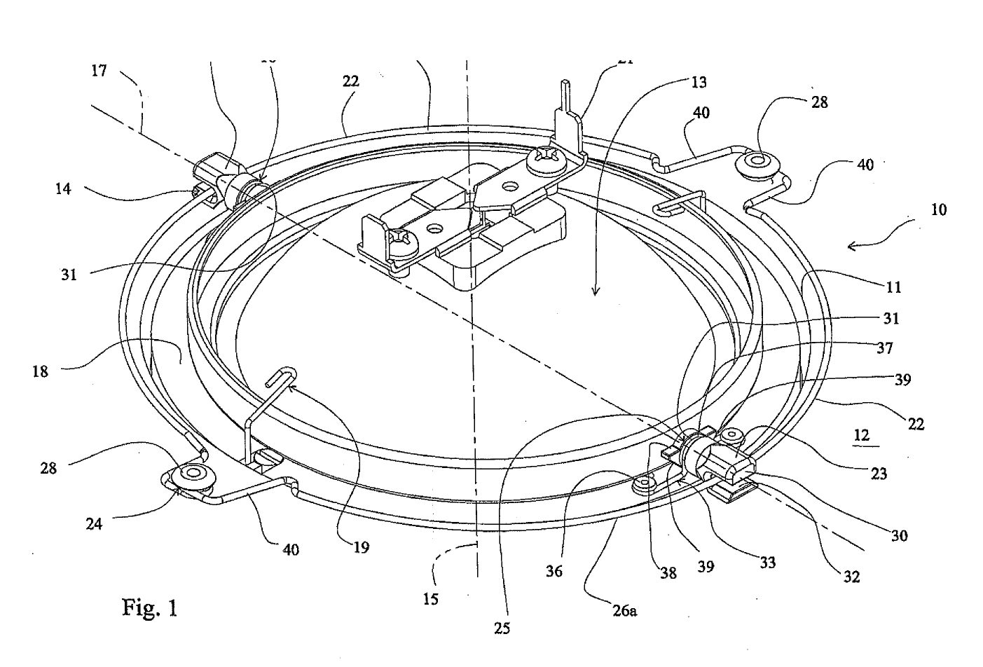

FIG. 2 is an exploded perspective view of a part of the appliance shown in FIG. 1;

FIG. 3 shows a cross section side view of the appliance shown in the previous figures, attached to a convex panel.

### DETAILED DESCRIPTION OF THE INVENTION

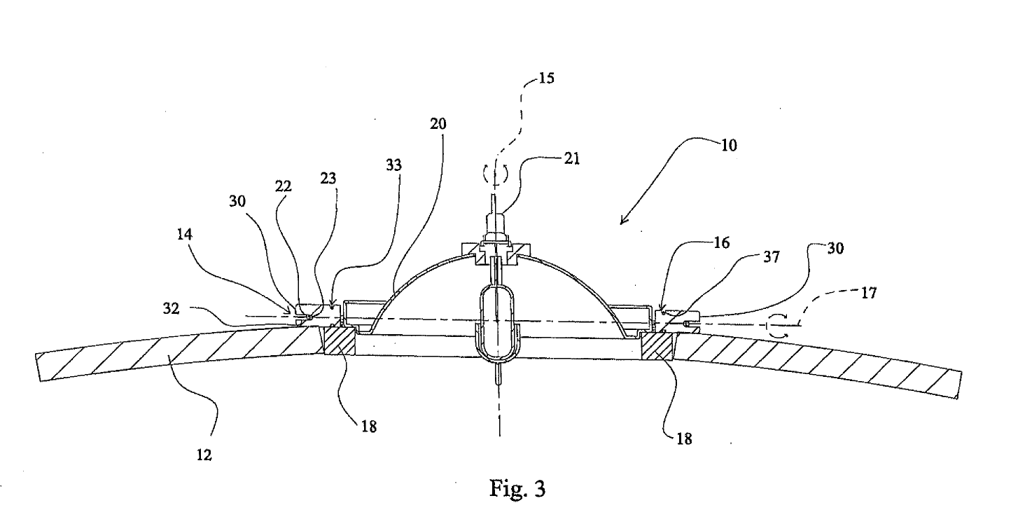

With reference to the above figures, a lighting appliance according to the invention is globally indicated by the numeral 10. Said lighting appliance 10 is of the type designed for being arranged in a hole, indicated by the numeral 11, provided in a supporting structure 12, that—in this example—is a panel (indicated hereinafter using the same number as for the supporting structure) forming part of a wall or false ceiling (or any other equivalent supporting structure); in the embodiment described herein, as an example, said panel 12 is convex as shown clearly in FIG. 3.

In its essential components, the appliance 10 comprises a lamp body 13, first means 14 (described below) for swivelling the lamp body 13 around a first axis, indicated by the numeral 15, that points substantially towards the area to be illuminated, and second means 16 (also described later on) for swivelling the lamp body 13 around a second axis 17, lying crosswise (and, in this particular example, orthogonally) to the first axis 15.

The lamp body 13 comprises a circular frame 18 to which a reflector 20 is reversibly attached by means of quick coupling means 19 (of known type), in said reflector 20 being arrangeable a light source L, electrically connectable to the mains power supply using electrical connection means of known type 21 integrated in the reflector 20.

The first swivelling means 14 comprise a turning pair with an axis of rotation coinciding with the first axis 15. The two kinematic component parts of the turning pair, globally indicated by 22 and by 23, are associated respectively with means 24, described later on, for attaching the turning pair to the panel 12 and with means 25, also described later on, for restraining the turning pair to the lamp body 13.

In particular, a first one 22 of the two kinematic component parts forming the turning pair is associated in this embodiment with the aforesaid attaching means 24, while the second one 23 is associated with the restraining means 25.

The first part 22 of the turning pair 22-23 comprises a substantially annular guiding element surrounding the hole 11 in the panel 12, the dimensions of which extend mainly in the axial direction. The substantially annular guiding element comprises two opposite facing C-shaped concave tracks 26a and 26b, both facing towards the first axis 15, made of an elastically bendable material. In this embodiment, each concave tracks 26a or 26b consists of an elastically bendable threadlike metal body (made, for instance, of harmonic steel). The two concave tracks 26a and 26b are connected together at their respective ends.

In particular, these concave tracks 26a and 26b are identical to one another and arranged in a substantially symmetrical position with respect to the first axis 15 (around which the turning pair 22-23 revolves).

The ends of the concave tracks 26a and 26b are shaped to form eyelets 27a and 27b; rivets 28 are engaged in corresponding eyelets (27a and 27b) and inserted in corresponding seats 29 defined in the panel 12 (said eyelets 27 and rivets 28 embody the previously-mentioned means 24 for attaching the first component part 22 of the turning pair to the panel 12).

An important feature of the structure of the appliance 10 lies in that the two concave tracks 26a and 26b thrust against the second component part 23 of the turning pair 22-23 so as to generate a friction during their relative rotation.

In this embodiment, the thrust is assured by the fact that, when the lamp body 13 is detached from the panel 12, the distance between points on the guiding element 26a-26b lying symmetrically opposite one another with respect to the first axis of rotation 15 (i.e. points belonging to separate concave tracks 26a or 26b) is narrower than the distance between the corresponding portions of the second component part 23, on either side of the first axis 15, required to slide along the guiding element.

The guiding element 26a-26b is consequently always bent when it is coupled to the second part 23 of the turning pair 22-23 (in other words, there is an interference fit) and thrusts, due to an elastic reaction, against said second part 23, thus enabling a rotation with friction of the turning pair.

The second kinematic component part 23 of the turning pair 22-23 consists, in this embodiment, of two separate cursors 30 associated, using the above-mentioned restraining means 25, with the lamp body 13 in symmetrically opposite positions with respect to the first axis 15. The free ends of the cursors 30 have respective slots 32 shaped to slide on the guiding element 26.

The second means 16 for swivelling the lamp body 13 around the second axis 17 comprise the means 25 for restraining the cursors 30 to the lamp body 13. These restraining means 25 consist of two hinges 31 with axes of rotation coinciding with the second axis 17. These hinges 31 connect the cursors 30 to the circular frame 18 of the lamp body 13.

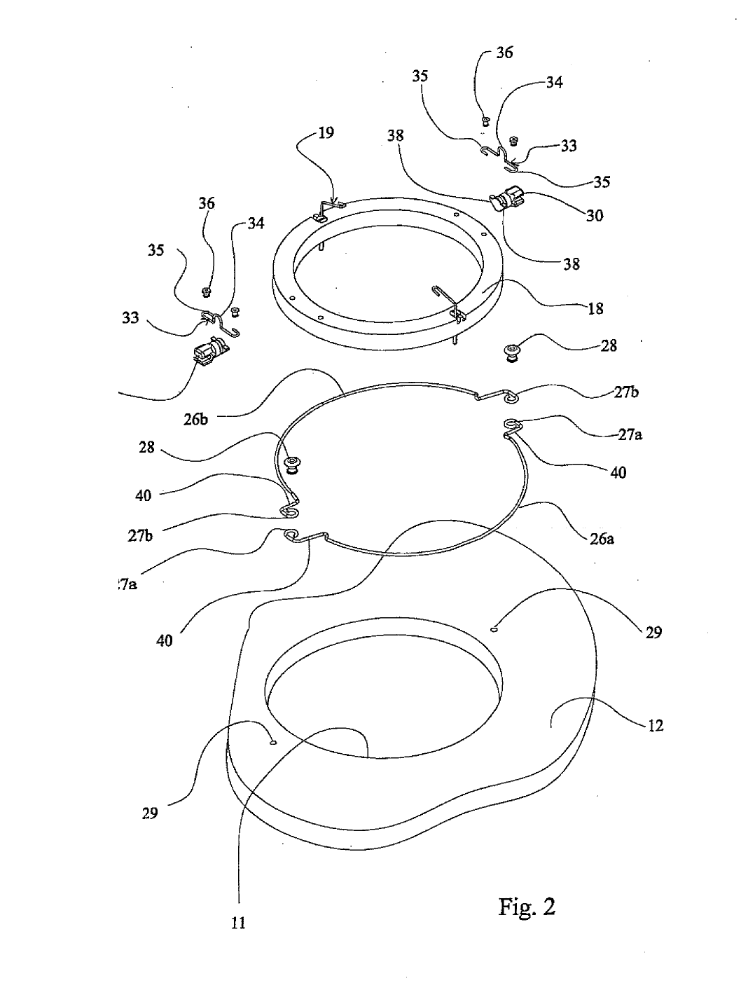

In particular, each hinge comprises a threadlike body 33, clearly visible in FIG. 2, that is elastically bendable (e.g. made of harmonic steel) and shaped so as to form a central U-shaped portions facing the frame 18 and to form eyelet-shaped two end portions 35 lied on a transverse plane (in this example, on a plane substantially orthogonal) to the plane on which the central U-shaped portion 34 lies. The two end portions 35 are fixed to the frame 18 by means of respective rivets 36. The central U-shaped portion 34 is elastically forced inside a annular groove 37 arranged on the lateral surface of a corresponding cursor 30. The cursor 30 can slide on the U-shaped portion 34. The cursors 30 constitute a rotation pin enabling the tilting of the lamp body 13.

On its lateral surface, on opposite sides with respect to the second axis of rotation 17, each cursor 30 has two protrusions 38 with respective sides 39 facing towards the frame 18 and slanting at an angle of 90° from one another in the present embodiment. The sides 39 of the protrusions 38 serve as limit stops for the rotation of the lamp body 13 in that they are designed to abut against the frame 18. The limit stops allow the lamp body to rotate through 90° around the second axis 17.

Likewise, both end portions of each concave track 26a or 26b of the guiding element have portions 40, extending crosswise to the C-shaped tracks that define limit stop abutments for the cursors 30. The lamp body 13 can thus rotate around the first axis 15 substantially over two tracks 26a and 26b that form nearly complete semi-circumferences.

In practice, it has been found that the invention as described above achieves the proposed objects.

In fact, the present invention provides a lighting appliance of the type designed for housing in a flush mounting hole formed in a panel of a wall or false ceiling that does not demand the formation of any annular grooves on the inner wall of the hole for housing the appliance.

This result derives from the fact that a sliding coupling is provided between the lamp body and the panel. This coupling is defined by a turning pair comprising a first kinematic component part that forms an elastically deformable annular guiding element attached to the not exposed side of the panel, and a second kinematic component part consisting of cursors attached to the lamp body, obliged to slide around said annular guiding element; the guiding element thrusts constantly against the cursors, thus assuring a stable positioning of the lamp body around the first axis (a fixed axis pointing towards the area to be illuminated).

In equivalent embodiments, the elastically deformable kinematic component part may be attached to the lamp body, so as to form a continuous circular cursor, while the second kinematic component part, forming a rigid component, may be attached to the panel and consist, for instance, of four appendages (fixed to the panel) lying around a circumference and defining respective grooves for guiding the continuous circular cursor.

It is also clear that a guiding element with only one elastically deformable track could also be used, since all that is necessary is an elastic reaction in the forced coupling between the guiding element and the cursors.

Such a structural solution thus enables the appliance to be used even with thin panels, since it is no longer necessary to provide a groove on the inner wall of the panel hole containing the appliance.

Moreover, the shape and type of the guiding element (basically two c-shaped concave threadlike bodies combined to form a annular body) allow an elastic deformation also in a direction normal to the panel. This enables the cursors to slide on a surface even if it is not flat, such as a convex surface (as in the example illustrated), because the guiding element can deform under the thrust generated by the cursors when they are obliged to slide over a surface having a variable angle of inclination. The appliance can thus be attached to a curved panel.

Moreover, the particular structure of the cursors and the way in which they are attached to the lamp body ensures a stable positioning of the lamp body around the second axis, which is used to adjust the tilting angle of the beam of light.

Said stability is assured by the forced rotational coupling between each cursor and a respective elastically bendable metal wire body fixed to the lamp body.

Finally, the structural design of the appliance is such that it consists of extremely simple components that are easy to manufacture and assemble.

Variants and/or changes may be made to the appliance according to the present invention without departing from the scope of the invention as set forth in the following claims.

Where any of the characteristics and techniques described in any of the claims are followed by reference signs, these have been included for the purpose of providing examples simply to increase the clarity of the claims and consequently, they have no limiting effect on the interpretation of each element they identify.

1. A lighting appliance for association with a supporting structure, the lighting appliance comprising:
a lamp body, the lamp body comprising a reflector in which a luminous source can be housed,
first means for swivelling said lamp body around a first axis pointing substantially towards an area to be illuminated,
second means for swivelling said lamp body around a second axis, lying crosswise to the first axis, designed for adjusting a tilting angle of said reflector,
wherein said first swivelling means comprise a turning pair with an axis of rotation coinciding with said first axis, the turning pair comprising two component kinematic parts, the two component kinematic parts being respectively associated with means for attaching the turning pair to the supporting structure in which the appliance is mounted, and means for restraining the turning pair to said lamp body, said two kinematic component parts comprising a first part comprising at least two opposite concave tracks with opposite concave sides facing one another and towards said first axis, at least one of two opposite concave tracks being elastically deformable and thrusting against the second component part of said turning pair to generate friction.

2. The lighting appliance according to claim 1, wherein said first component part is associated with said means for attaching the turning pair to the supporting structure, said first component part comprising a substantially annular element for guiding the second component part, the second component part being associated with said means for restraining the turning pair to said lamp body, said substantially annular element having dimensions extending in a mainly axial direction and being made of an elastically bendable material, wherein a distance between points on said substantially annular element that are substantially symmetrical with respect to said first axis is narrower, when said lamp body is detached from the supporting structure, than a distance between corresponding portions of said second component part, lying opposite one another with respect to the first axis, designed to slide along said substantially annular element.

3. The lighting appliance according to claim 2, wherein said substantially annular element comprises said two opposite concave tracks, each consisting of a separate elastically bendable threadlike metal body, said two opposite concave tracks being joined to one another at their respective ends.

4. The lighting appliance according to claim 3, wherein said means for attaching said first component part of the turning pair to the supporting structure comprise eyelets, formed on end portions of the two opposite concave tracks, and two rivets engaged in pairs of said eyelets and inserted in corresponding seats provided in the supporting structure.

5. The lighting appliance according to claim 3, wherein said two opposite concave tracks are identical to one another and arranged in a substantially symmetrical manner around said first axis.

6. The lighting appliance according to claim 2, wherein said second component part of said turning pair comprises two separate cursors associated by said restraining means with said lamp body in a symmetrical position with respect to said first axis, first ends of said cursors being shaped to slide along said substantially annular element that forms the first component part of said turning pair.

7. The lighting appliance according to claim 6, wherein said first ends of said cursors have respective through slots shaped to slide along said substantially annular element.

8. The lighting appliance according to claim 1, wherein said lamp body comprises a circular frame to which said reflector is reversibly attached using quick coupling means.

9. The lighting appliance according to claim 1, wherein said second means for swivelling said lamp body around the second axis comprise said means for restraining said cursors to said lamp body, said restraining means comprising two hinges with axes of rotation coinciding with said second axis.

10. The lighting appliance according to claim 9, wherein each of said hinges comprises an elastically bendable threadlike body with a U-shaped portion facing towards a circular frame to which said reflector body is reversibly attached and with at least one end portion attached to said frame, said U-shaped portion being elastically forced, but capable of sliding rotationally, in an annular groove formed on a lateral surface of a corresponding cursor.

11. The lighting appliance according to claim 10, wherein said threadlike body has two eyelet-shaped end portions lying on a plane crosswise to a plane on which the U-shaped portion lies, said two end portions being fixed to said frame by means of respective rivets.

12. The lighting appliance according to claim 6, wherein, on a lateral surface on either side of said second axis, at least one of said cursors has two protrusions with respective sides facing the frame and slanted with respect to one another, said sides of said protrusions serving as limit stops for rotation of said lamp body around said second axis.

13. The lighting appliance according to claim 6, wherein both end portions of each concave track of said guiding element have portions lying crosswise to the concave portion, serving as limit stops for said cursors.
